(19) United States
(12) Patent Application Publication
(10) Pub. No.: US 2012/0248079 A1
(43) Pub. Date: Oct. 4, 2012

(54) CENTERING STRUCTURE AND METHOD FOR MACHINING OF A SOLAR CELL

(75) Inventors: Miin-Tsair SU, Taipei (TW); Jou-Chin Liao, Fengshan City (TW); Chien-Pang Ting, Zhubei City (TW)

(73) Assignee: MARKETECH INTERNATIONAL CORP., Taipei (TW)

(21) Appl. No.: 13/075,416

(22) Filed: Mar. 30, 2011

(51) Int. Cl. B23K 26/02

(52) U.S. Cl. 219/121.82

(57) ABSTRACT

A centering structure for machining of a solar cell has a first and second retainer, set separately onto two lateral locations close to X, Y axes on the machining table. Two adjacent sides of the solar cell are abutted onto the retainers. A first and second clamping device, set separately onto two other lateral locations close to X, Y axes on the machining table is used to abut onto and clamp the other two sides of the cell through displacement. Distance measuring equipment attached onto the clamping devices, is used to detect the clamping displacement, or the relative distance between the clamping devices and the cell, or the relative distance between the equipment and the cell. An ALU connected with the equipment calculates the centering position of the cell according to the preset relative distance between the clamping devices and retainers as well as the distance measured by the equipment.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a solar cell machining technology, and more particularly to an innovative one which is machined with a centering structure via a machining method.

2. Description of Related Art Including Information Disclosed Under 37 CFR 1.97 and 37 CFR 1.98.

The solar cell features frangibility and bigger dimensional tolerance, or even up to 1 mm (156±0.5 mm) for a 6 inch type. Given such characteristics of a solar cell, the centering of raw material generally relies on a CCD (Charge Coupled Device) for capturing, and then permits calculation through the captured edge value as shown in the process flow in FIG. 1. The gripping force cannot be too strong in order to avoid breakage or warpage of the chips.

Generally speaking, the time of laser machining is fixed, but CCD edge finding and positioning is focused according to the vehicle manufacturers' method of reducing TACT TIME. For the purpose of higher accuracy, several sets of high-resolution CCDs are arranged on the distributed edges of the solar cells to capture simultaneously their edge images. Or, a single CCD is used to capture images through displacement of an X-Y machining table to various positions. The former method requires higher cost and mechanical complexity, and the latter one requires more time on image capturing.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

Based on the unique structure of “a centering structure for machining of a solar cell” of the present invention wherein said distance measuring equipment is used to detect the clamping displacement of the first and second clamping devices, or the relative distance between the clamping end of the first/second clamping devices and the side of the solar cell, or the relative distance between the distance measuring equipment and the side of the solar cell during displacement of the first and second clamping devices, it is possible to calculate the accurate centering position of the solar cell when the first and second clamping devices are abutted onto the other two adjacent sides of the solar cell, thus realizing lower cost and high machining efficiency with improved applicability.

### BRIEF DESCRIPTION OF THE SEVERAL VIEWS OF THE DRAWINGS

FIG. 1 is a flow chart showing the process of the prior art.

FIG. 2 is an upper perspective view of the preferred embodiment of the present invention.

FIG. 3 is a schematic view of the preferred embodiment of the present invention.

FIG. 4 is a schematic view of another distance measuring equipment of the present invention.

FIG. 5 is a schematic view of another distance measuring equipment of the present invention.

FIG. 6 is a schematic view of another distance measuring equipment of the present invention.

### DETAILED DESCRIPTION OF THE INVENTION

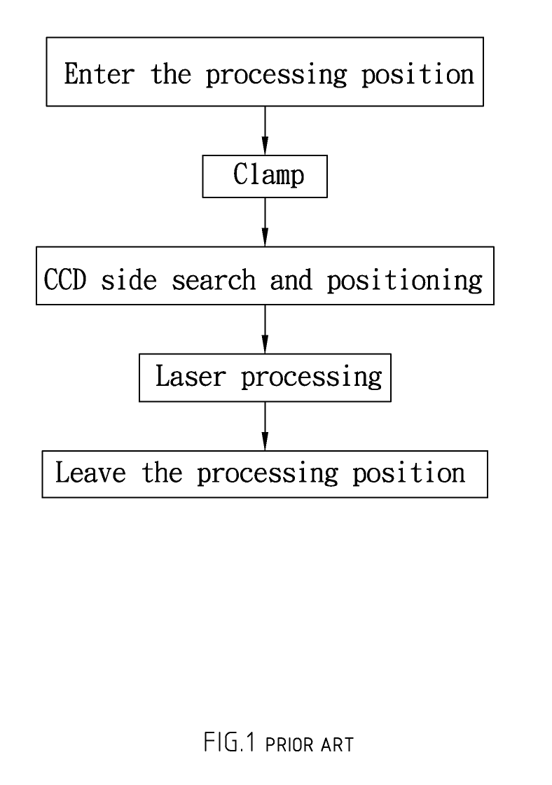

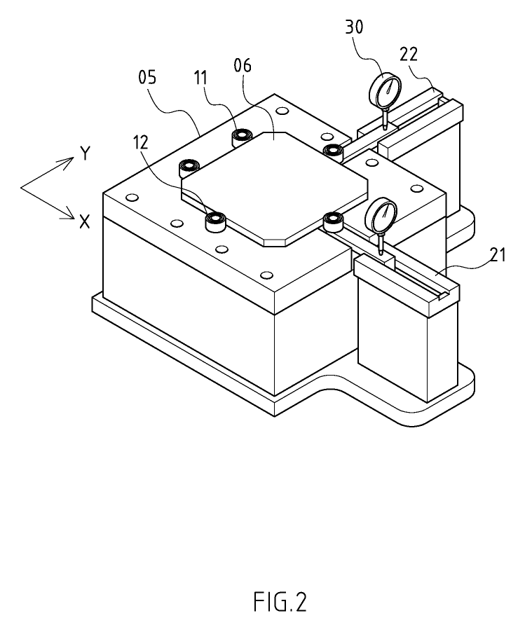

FIGS. 1-3 depict preferred embodiments of a centering structure and machining method of a solar cell of the present invention, which, however, are provided for only explanatory objective for patent claims. Said centering structure for machining of a solar cell allows one to obtain the accurate centering position of the solar cell 06 fastened on the machining table 05. The centering structure includes a first retainer 11 and a second retainer 12, set separately onto two lateral locations close to X, Y axes on the machining table 05 for placement of the solar cell 06. When the solar cell 06 is placed, two adjacent sides of the solar cell 06 are abutted onto the first and second retainers 11, 12.

A first clamping device 21 and a second clamping device 22 are set separately onto two other lateral locations close to the X, Y axes on the machining table 05 correspondingly to the first and second retainer 11, 12, and used to abut onto and clamp the other two sides of the solar cell 06 through displacement.

Distance measuring equipment 30 is attached onto either position of the first and second clamping devices 21, 22 of the machining table 05. Said distance measuring equipment 30 is used to detect the clamping displacement of the first and second clamping devices 21, 22, or the relative distance between the clamping end of the first/second clamping devices 21, 22 and the side of the solar cell 06, or the relative distance between the distance measuring equipment 30 and the side of the solar cell 06.

An ALU 40 (arithmetic logic unit) is electrically connected with the distance measuring equipment 30, and used to calculate the accurate centering position of the solar cell 06 according to the preset relative distance between the first/second clamping devices 21, 22 and first/second retainers 11, 12 as well as the distance measured by the distance measuring equipment 30.

Of which, the first and second retainers 11, 12 can be made of bearing that enables fixed-point rotation.

Said distance measuring equipment 30 can be represented in the following patterns. Said distance measuring equipment 30 is attached onto the first and second clamping devices 21, 22.

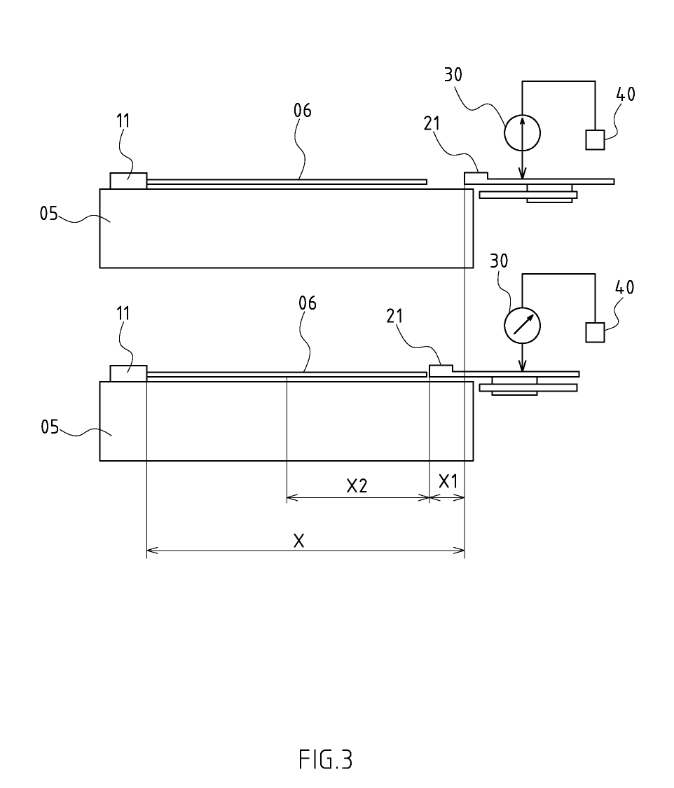

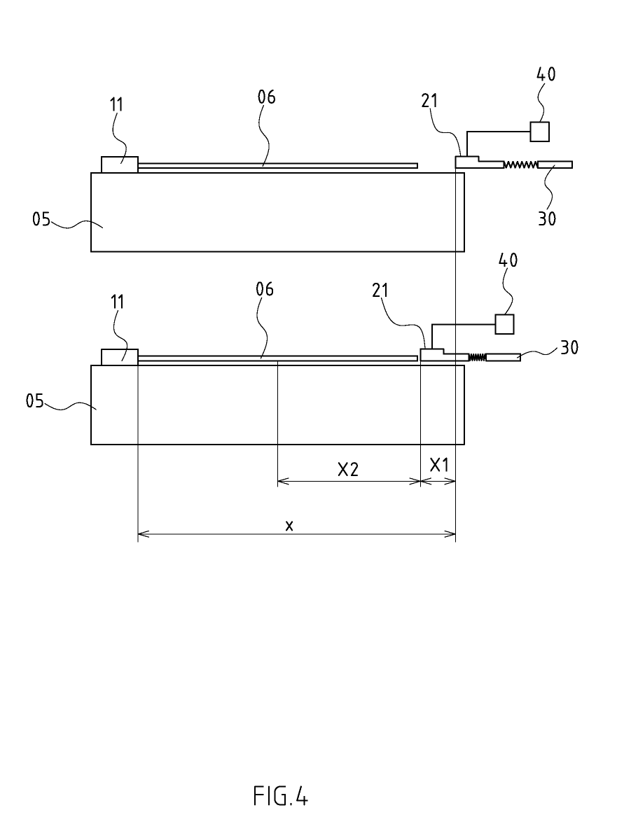

Referring to FIGS. 3, 4, the distance measuring equipment 30 is comprised of a thrust meter and contact measurer, so as to detect the clamping displacement of the first and second clamping devices 21, 22. The distance from non-actuated first/second clamping devices 21, 22 and solar cell 06 to one side of the first/second retainers 11, 12 is known (indicated by X shown in FIGS. 3, 4). When the first and second clamping devices 21, 22 shift towards one side of the solar cell 06 for clamping, the displacement distance could be obtained by the distance measuring equipment 30 comprised of thrust meter and contact measurer (indicated by X1 shown in FIGS. 3, 4), then the external dimension of the solar cell 06 could be estimated by ALU 40 electrically connected with the distance measuring equipment 30, so as to estimate the distance from the side to the center of the solar cell 06 (indicated by X2 shown in FIGS. 3, 4), thereby obtaining the accurate centering position of the solar cell 06.

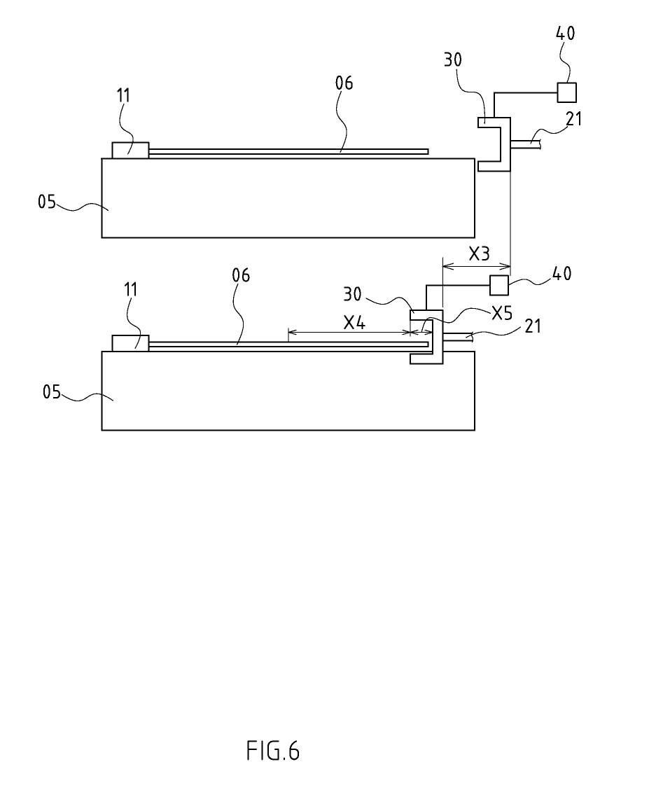

Referring also to FIG. 6, the distance measuring equipment 30 is a contrast photoelectric sensor used to detect the relative distance between the clamping end of the first/second clamping devices 21, 22 and the side of the solar cell 06. When two adjacent sides of the solar cell 06 are abutted onto the first and second retainers 11, 12, the contrast photoelectric sensor is displaced such that its center is located correspondingly to the solar cell 06. As the displacement distance of the contrast photoelectric sensor is fixed (indicated by X3 shown in FIG. 6), when the solar cell 06 is located correspondingly to the contrast photoelectric sensor, X5 is displayed on said contrast photoelectric sensor, allowing one to estimate the distance from the side to the center of the solar cell 06(indicated by X4 shown in FIG. 6).

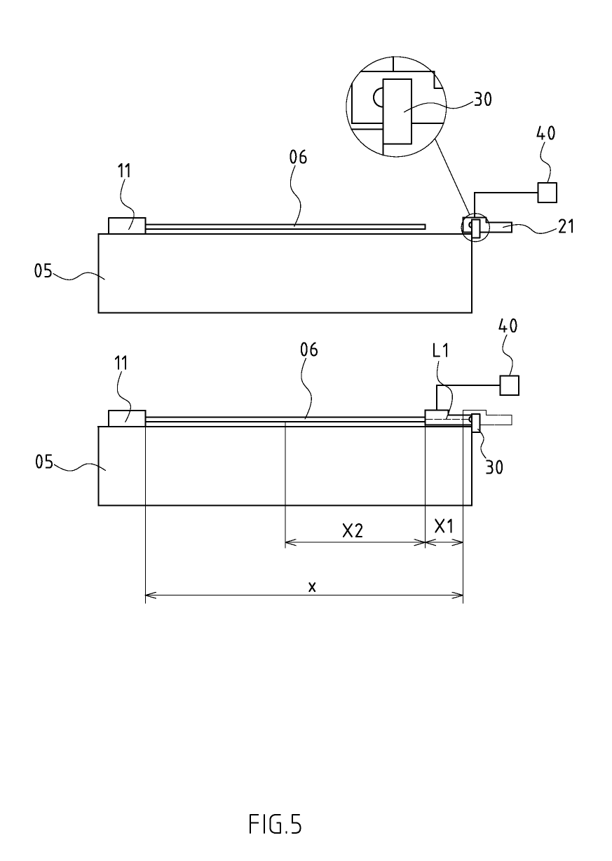

Referring also to FIG. 5, said distance measuring equipment 30 is attached onto the machining table 05. The distance measuring equipment 30 is a reflection photoelectric sensor with distance reading feedback functions. The distance from non-actuated first/second clamping devices 21, 22 and solar cell 06 to one side of the first/second retainers 11, 12 is known (indicated by X shown in FIG. 5). When the first and second clamping devices 21, 22 shift to clamp the solar cell 06, and two adjacent sides of the solar cell 06 are abutted onto the first and second retainers 11, 12, the photoelectric sensor will transmit sensing light L1 to the other two adjacent sides of the solar cell 06. In such a case, the photoelectric sensor could display the detected distance (indicated by X1 shown in FIG. 5), and estimate the distance from the side to the center of the solar cell 06 (indicated by X2 shown in FIG. 5).

Based on the above-specified structure, the centering method for machining of said solar cell is described below:

First, place the solar cell 06 on the machining table 05.

Next, abut onto and clamp two adjacent sides of the solar cell 06 through displacement of the first and second clamping devices 21, 22, and make the other two adjacent sides of the solar cell 06 abut onto the first and second retainers 11, 12 for positioning the solar cell 06.

Next, during displacement of the first and second clamping devices 21, 22, employ the distance measuring equipment 30 to detect the clamping displacement of the first and second clamping devices 21, 22, or the relative distance between the clamping end of the first/second clamping devices 21, 22 and the side of the solar cell 06, or the relative distance between the distance measuring equipment 30 and the side of the solar cell 06.

Finally, employ an ALU 40 to calculate the accurate centering position of the solar cell 06 according to the preset relative distance between the first/second clamping devices 21, 22 and first/second retainers 11, 12 as well as the distance measured by the distance measuring equipment 30.

1. A centering structure for machining of solar cell, used to obtain the accurate centering position of the solar cell fastened on the machining table, said centering structure comprising:
a first and second retainer, set separately onto two lateral locations close to X, Y axes on the machining table for placement of the solar cell; when the solar cell is placed, two adjacent sides of the solar cell are abutted onto the first and second retainers;
a first and second clamping device, set separately onto two other lateral locations close to X, Y axes on the machining table correspondingly to the first and second retainer, and used to abut onto and clamp the other two sides of the solar cell through displacement;
distance measuring equipment, attached onto either position of the first and second clamping devices of the machining table; said distance measuring equipment is used to detect the clamping displacement of the first and second clamping devices, or the relative distance between the clamping end of the first/second clamping devices and the side of the solar cell, or the relative distance between the distance measuring equipment and the side of the solar cell;
an arithmetic logic unit, electrically connected with the distance measuring equipment, and used to calculate the accurate centering position of the solar cell according to the preset relative distance between the first/second clamping devices and first/second retainers as well as the distance measured by the distance measuring equipment.

2. The structure defined in claim 1, wherein the first and second retainers can be made of bearing that enables fixed-point rotation.

3. The structure defined in claim 1, wherein the distance measuring equipment is comprised of a thrust meter and contact measurer, so as to detect the clamping displacement of the first and second clamping devices.

4. The structure defined in claim 1, wherein the distance measuring equipment is either a reflection photoelectric sensor or contrast photoelectric sensor used to detect the relative distance between the clamping end of the first/second clamping devices and the side of the solar cell.

5. A method for centering a solar cell for machining comprising:
place the solar cell on the machining table;
abut onto and clamp two adjacent sides of the solar cell through displacement of the first and second clamping devices, and make the other two adjacent sides of the solar cell abut onto the first and second retainers for positioning the solar cell;
during displacement of the first and second clamping devices, employ the distance measuring equipment to detect the clamping displacement of the first and second clamping devices, or the relative distance between the clamping end of the first/second clamping devices and the side of the solar cell, or the relative distance between the distance measuring equipment and the side of the solar cell;
employ an arithmetic logic unit to calculate the accurate centering position of the solar cell according to the preset relative distance between the first/second clamping devices and first/second retainers as well as the distance measured by the distance measuring equipment.
